(19) United States
(12) Patent Application Publication
(10) Pub. No.: US 2005/0056962 A1
(43) Pub. Date: Mar. 17, 2005

(54) Method of making coated braided hose assembly

(76) Inventor: Norman S. Martucci, Clarkston, MI (US)

Correspondence Address: Amy E. Rinaldo;KOHN & ASSOCIATES, PLLC, Suite 410, 30500 Northwestern Highway, Farmington Hills, MI, 48334, US

(21) Appl. No.: 10/663,259

(22) Filed: Sep. 16, 2003

(51) Int. Cl. B32B 1/08

(52) U.S. Cl. 264/171.27; 264/171.12; 156/143

(57) ABSTRACT

According to the present invention, there is provided a method constructing a hose assembly made by a hose assembly by applying a braided reinforcing material having gaps extending therethrough about an inner tubular layer, opening gaps in the braided reinforcing material dispersing a polymeric material into the gaps of the reinforcing material. Also provided is a hose assembly dispersion reservoir having a reservoir tank for containing a polymeric material and opening objects for opening gaps in a braid disposed over the hose assembly while passing the hose assembly through the reservoir tank.

### BACKGROUND OF THE INVENTION

1. Technical Field

The invention relates to a method of making a hose assembly. Specifically, the present invention relates to a method of making a hose assembly adapted for carrying vehicle fuels.

2. Background Art

Hose assemblies used to carry fuels are well known in the art. The hose should preferably be strong and resistant to heat and chemical degradation. These hoses are subject to chemical breakdown by the various fluids, which flow through them. Further, these hoses are typically routed through tortuous paths to the engine compartment of the vehicle to deliver fuel to the engines. These engines are hot and thus, the hoses used to carry fuel are subject to the breakdown from the heat.

Teflon® hoses provide the necessary physical properties for carrying fuels. A major problem with these types of hoses is that when used alone, i.e., only a Teflon layer as a conduit, they tend to bend during installation and kink. This deformation remains permanent and provides constant resistance to fluid flow through the hose.

To solve this problem, a prior art hose assembly includes an inner Teflon tubular member. The inner tubular member is surrounded by a tightly wound metallic braid. The metallic braid allows the Teflon inner tubular member to bend at a certain degree without kinking. However, if bent past a certain point the metallic braid aids in the kinking of the inner tubular member.

This prior art assembly has three major disadvantages. First, the metallic braid tends to abraid the interior of the inner tubular member. This causes leaks in the inner tubular member. The second problem is that the exterior metallic braided casing is thermally and electrically conductive. More important is that the metallic braid will retain heat and transfer the heat to the fuel moving through the inner tubular member causing fuel system problems. Finally, when used in the automobile environment, the metallic braid transmits noise during operation of the vehicle, which is undesirable.

U.S. Pat. No. 4,111,237 to Mutzner et al., which issued Sep. 5, 1978, discloses a hose assembly. The assembly includes a polychloroprene inner layer. The glass fiber is then braided about the exterior of the inner layer. A rubber layer is then added and wrapped over the braided layer. A second braided layer of nylon is then placed about the rubber layer. Finally, a cover of polychloroprene is then extruded about the second braided layer.

U.S. Pat. No. 3,547,162 to Schuerer issued Dec. 15, 1970, discloses a plastic pipe assembly. The assembly includes an inner layer of a synthetic plastic made from cross link olefinic polymers. A fiber braided layer is disposed over the inner layer. Finally, a foamed layer of synthetic plastic is disposed about the synthetic fiber reinforcement. Utilizing cross linked olefinic polymers is in-efficient in that it cannot be used to carry vehicle fuels, as such fuels would degrade the inner layer. Further, this assembly requires a very thick outer casing to provide the necessary strength.

Accordingly, it would be useful to develop a fuel hose assembly and method, which efficiently and effectively enables a braided layer to be added to the inner layer for carrying fuel.

### SUMMARY OF THE INVENTION

According to the present invention, there is provided a method constructing a hose assembly made by a hose assembly by applying a braided reinforcing material having gaps extending therethrough about an inner tubular layer, opening gaps in the braided reinforcing material dispersing a polymeric material into the gaps of the reinforcing material. Also provided is a hose assembly dispersion reservoir having a reservoir tank for containing a polymeric material and opening objects for opening gaps in a braid disposed over the hose assembly while passing the hose assembly through the reservoir tank.

### DESCRIPTION OF THE DRAWINGS

Other advantages of the present invention will be readily appreciated as the same becomes better understood by reference to the following detailed description when considered in connection with the accompanying drawings wherein:

FIG. 1 shows a device for performing the method of the present invention; and

FIG. 2 shows the hose assembly of the present invention.

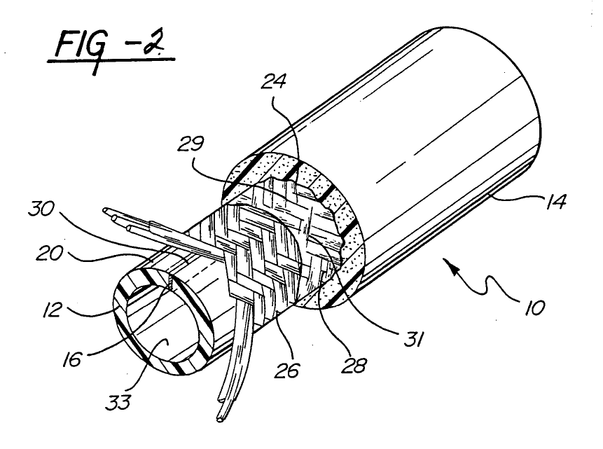

### DETAILED DESCRIPTION OF THE INVENTION

The hose assembly made in accordance with the method of the instant invention is generally shown as 10 in the figures. The assembly 10 includes the tubular member, generally indicated as 11, and coupling means, generally indicated as 20, for connecting the ends of the tubular member 11 to fittings for conducting fluid therethrough.

The tubular member 11 includes an inner organic polymer at the layer 12. The layer is preferably extruded and has a wall thickness of between 0.001 and 0.120″. The inner layer 12 is preferably made of a fluorocarbon polymer. Specifically, the inner layer is made of a polymer of tetrafluoroethylene (PTFE), the polymer afluorenated ethylene propylene (FEP), the polymer of perfluoroalkoxy resin (PFA), or the polymer of ethlyene-tetrafluoroethylene (ETFE). The fluorocarbon polymers PTFE, FEP and PFA are sold under the trademark TEFLON by Dupont. The polymer ETFE is sold under the trademark TEFCEL by Dupont.

The inner layer 12 is impervious to fluid flow through the wall. Since the inner layer 12 is preferably made of a fluorocarbon polymer material, it is resistant to both heat and chemical degradation. This allows a variety of fluids, particularly vehicle fuels, to pass through the interior of the layer 12 without corroding the layer 12.

The assembly 10 further includes a reinforcing braided or woven layer 13 about the exterior of the inner layer 12. The braided or woven layer 13 can comprise any nonmetallic material disposed in interweaving fashion or wrapped tightly about the inner layer 12. Preferably the material to be used for the braided layer 13 is glass fiber. Glass fibers provide the necessary strength. Further, glass fibers are heat resistant which is important for use in heated environments and for making the assembly as will be described subsequently.

The braided or woven fibers can be tightly wound or they can be loosely wound about the inner layer 12 having wide gaps between adjacent fibers. In the preferred embodiment, the glass fibers are tightly woven such that the gaps or spaces between adjacent fibers is minimal. The braided layer 13 adds to the strength of the inner layer 12. Particularly, by using a braided layer 13, the working pressure of the inner layer 12 is increased, allowing a higher pressure fluid to flow through the inner layer 12. Further, the braided layer 13 adds to the tensile strength of the hose assembly 10. When coupling members 20 are disposed on the ends of the tubular member 11, as will be described subsequently, the braided layer 13 increases the tensile strength of the hose assembly 10 sufficiently to fixedly connect any type of coupling member 20 to the tubular member 11. Finally, the braided layer adds to the hoop strength of the inner layer.

The assembly 10 further includes an organic polymeric dispersion or coating 14 in the braided layer 13. Specifically, an organic polymeric material is dispersed about the braided layer 13 and is located on the outer periphery of the braided layer 13 radially inwardly toward the inner layer 12 (as best viewed in FIG. 4). The organic polymeric material is deposited in the intricies of the braided layer 13. The coating 14 preferably comprises a fluorocarbon polymer. Specifically, the coating 14 comprises the polymer of tetrafluoroethylene (PTFE), the polymer of fluorinated ethylene propylene (FEP), the polymer of perfluoroalkoxy resin (PFA), or the polymer of ethylene-tetrafluoroethylene (ETFE).

The coating 14 covers or coats the glass fibers of the braided layer 13. That is, the coating 14 covers the fibers of the braided layer 13 from the outer periphery radially inward. The coating 14 therefore, does not extend radially outwardly from the outer periphery of the braided layer 13. After the material has been coated, each fiber is discernible. In effect, what results is a coating 14 having the braided layer 13 therein.

The outer coating 14 is preferably formed by first braiding or wrapping the material 13 about the exterior of the inner layer 12. The organic polymeric material is then dispersed into the braided material 13 from the outer periphery of the braided layer 13 radially inwardly toward the inner layer. Preferably, the organic polymeric material is a fluorocarbon polymer in a dispersion. In other words, the coating 14, as applied, comprises the fluorocarbon polymer and at least one carrying fluid. The preferable fluid is water. It is appreciated that any suitable fluid can be used. The fluorocarbon polymer solution coats or is dispersed throughout the entire braided layer 13. Specifically, the fluorocarbon polymer dispersion effectively coats each of the glass fibers from the outer periphery radially inwardly. That is, the glass fibers are coated such that any gap between adjacent fibers are filled with the polymer dispersion. Also, the outer periphery of each fiber is completely coated. The carrying fluid is then removed from the dispersion by drying. This leaves a fluorocarbon polymer material dispersed throughout braided layer 13.

As previously stated, both the inner layer 12 and coating 14 are preferably fluorocarbon polymers. It is, however, not necessary that both the inner layer 12 and coating 14 be of the same fluorocarbon polymer. For example, the inner layer 12 can be made of PFA while the coating 14 is made of PTFE. Any combination of the fluorocarbon polymers previously listed can be utilized for the inner layer 12 and coating 14.

The coating 14, in conjunction with the braided layer 13, allows the inner layer 12 to be bent without kinking. That is, the coating 14 dispersed throughout the braided layer 13 provides strength to the inner layer 12 upon bending. This is commonly referred to as hoop strength. Thus, by using a polymeric coating 14 dispersed throughout the braided layer, a trim profile assembly is produced which results in the hoop strength of the tubular member 11 being increased so that the tubular member 11 can be bent without kinking the inner layer 12. Further, the outer coating 14 adds to the working pressure of the hose. That is, the coating 14 provides strength and allows the inner layer 12 to accommodate a fluid under pressure. Also, the coating 14 hinders abrasion of the tubular member. In other words, the coating 14 aids in abrasion resistance of the tubular member 11. Since the coating is continuous about the outer periphery of the braided layer 13, the braided layer is not subject to abrasion and instead resists abrasion. The coating 14 resists abrasion.

As fluid flows through the inner layer 12, electrical charges tend to build throughout the length of the inner layer 12. In order to prevent these electrical charges from accumulating, the inner layer 12 has an integral longitudinal conductive layer coextensive with the length of the inner layer 12 for conducting an electrical charge through the layer. Preferably, the inner layer 12 has a conductive strip 16 of carbon black. This carbon black is electrically conductive and dissipates any electrical charges built up by the fluid. Alternatively, the whole inner tubular member 12 can comprise the conductive means. This is done by using carbon black about the entire inner layer 12. The braided layer 13 and coating 14 are preferably electrically non-conductive. This is important in that electrical changes applied to the exterior of the outer coating 14 are not be conducted throughout the length of the tubular member 11 or to the fluid passing through the interior of the inner layer 12. It is appreciated that other conductive material can be used to form the conductive strip 16.

In the preferred method of making a hose assembly, an inner organic polymeric tubular member 12 is provided. Specifically, the inner tubular member 12 is a fluorocarbon polymer, which is extruded. A nonmetallic or wound material (preferably glass fiber) is then braided or wound about the exterior of the inner layer 12 to form a braided layer 13. An organic polymeric material dispersion 14 is then dispersed throughout the braided layer 13 from the outer periphery radially inward toward the inner layer 12.

Specifically, the inner layer 12 and braided material 13 are passed through a reservoir 22 containing a dispersion 14 of an organic polymeric material and at least one carrying fluid. While in this reservoir 22, the hose 10 passes through a series of opening/bending objects, 24, 26, 28 preferably, circular or round objects. The objects can be in the form of pulleys, wheels, a tubular assembly or the like. These objects are utilized to bend the hose assembly 10 such that as the hose assembly 10 passes through the turns, the dispersion material 14 is able to enter into the crevices of the braided layer 13 and thus form a more solid bond between the braid layer 13 and the inner layer 12.

The dispersion material 14 is able to enter the crevices of the braided layer 13 because the bending objects 24, 26, 28 open and close the gaps in the braided layer 13 without stretching the braided layer 13. This opening and closing can occur by bending, twisting or otherwise opening and closing the gaps in the braided layer 13 of the hose assembly 10 in such a manner as to insure that the gaps of the braided layer 13 are fully opened and closed while not distorting the gaps, or causing any stretching of the braided layer 13. The opening and closing of the gaps enables air to escape from braided layer 13. The escaping gas causes a vacuum that in turn draws in the emulsion. Therefore, the bending of the hose assembly 10 not only enables the emulsion to enter the braided layer 13, but actually draws the emulsion into the braided layer 13.

The opening/bending objects are all adjustable, thus enabling the same reservoir to be utilized for multiple hose assemblies 10. The opening/bending objects are adjustable in both vertical or horizontal directions such that they create the proper bend in the hose assembly 10 to efficiently and effectively allow for the dispersement material to enter the crevices of the hose assembly 10.

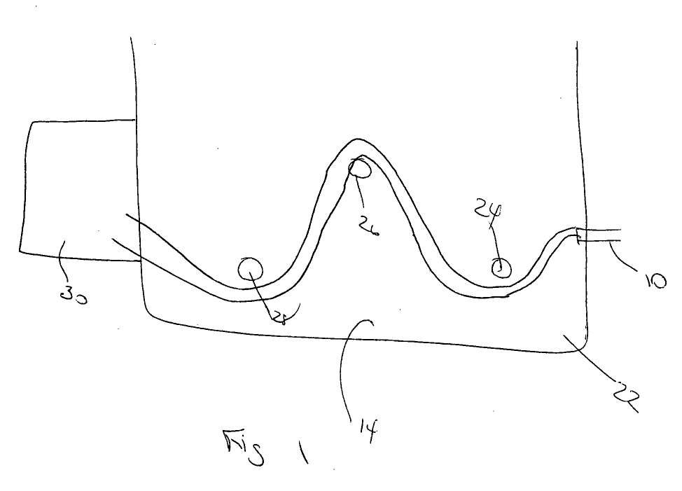

As shown in FIG. 1 of the preferred embodiment, three bending objects are utilized in the method of the present invention. Specifically, the hose assembly 10 enters the reservoir from the right, and is bent under the first bending object 24. The hose 10 proceeds in an upward fashion over the second bending object 26 and then proceeds downward again, passing beneath the next bending object 28. The hose 10 then proceeds upward into an oven 30 or other heating device for heating the entire hose assembly 10. At locations 1 and 2 of the bending objects, bubbles are seen in the dispersion materials. These bubbles indicate air is being released from the braid and thus establishing that the dipping is effectively getting into the crevices of the hose braid 13. There should not be bubbles present after the hose assembly 10 has gone through the third or final turnable object.

As the hose assembly 10 leaves the reservoir, there is a signal, which shows whether there has been an effective binding of the hose 10 and braid 13. Specifically, if the meniscus is effectively going upward, that establishes that the hose assembly 10 is sufficiently soaked with the dispersion material 14. However, if the meniscus goes downward, there are dry spots in the hose assembly 10 and thus the hose assembly 10 has not been effectively coated.

After leaving the reservoir, the hose assembly 10 is heated to remove excess liquid dispersion. This heating sinters the braided layer 13 to the inner layer 12.

This overcomes the problems associated with the prior art in that it enables the sufficient bonding of the braid 13 and the hose inner layer 12 without requiring multiple dips. Thus, there is a dramatic decrease in the cost required for attaching the braid 13 to the inner layer 12.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology, which has been used is intended to be in the nature of words of description rather than of limitation.

Obviously, many modifications and variations of the present invention are possible in light of the above teachings. It is, therefore, to be understood that within the scope of the appended claims, the invention may be practiced otherwise than as specifically described.

1. A method of constructing a hose assembly comprising the steps of:
applying a braided reinforcing material having gaps extending therethrough about an inner tubular layer;
opening gaps in the braided reinforcing material;
dispersing a polymeric material and a carrier fluid into the gaps of the reinforcing material; and
sintering the assembly.

2. The method according to claim 1, wherein said opening step further includes bending the tubular inner layer having the reinforcing material braided thereover.

3. The method according to claim 2, wherein said bending step further includes entraining the tubular inner layer with the braided reinforcing material through a series of bends.

4. The method according to claim 2, wherein said bending step includes drawing the emulsion into the gaps of the reinforcing material.

5. The method as set forth in claim 1, wherein said dispersing step further includes passing the tubular layer through a reservoir containing the dispersion of the second polymeric material.

6. A hose assembly dispersion reservoir comprising:
a reservoir tank for containing a polymeric material;
opening means for opening gaps in a braid disposed over the hose assembly while the hose assembly passes through said reservoir tank.

7. The hose assembly dispersion reservoir according to claim 6, wherein said opening means includes at least one pulley having an outer surface for entraining the hose assembly thereover.

8. The hose assembly dispersion reservoir according to claim 6, wherein said opening means are horizontally and vertically adjustable.

9. A hose assembly made by the process of:
applying a braided reinforcing material about an inner tubular layer;
opening gaps in the braided reinforcing material;
dispersing a polymeric material and a carrier fluid into the gaps of the reinforcing material; and
sintering the assembly.

10. The hose assembly according to claim 9, wherein said dispersing step further includes bending the tubular inner layer having the reinforcing material braided thereover.

11. The method according to claim 10, wherein said bending step further includes entraining the tubular inner layer with the braided reinforcing material through a series of bends.

12. The method according to claim 10, wherein said bending step includes drawing the emulsion into the gaps of the reinforcing material.
